(19) United States
(12) Patent Application Publication
(10) Pub. No.: US 2025/0341843 A1
(43) Pub. Date: Nov. 6, 2025

(54) DATA SUPPLY DEVICE, STORAGE MEDIUM, AND DATA SUPPLY METHOD

(71) Applicant: CANON KABUSHIKI KAISHA, Tokyo (JP)

(72) Inventors: Yujiro SOEDA, Kanagawa (JP); Masakazu FUJIKI, Kanagawa (JP)

(21) Appl. No.: 19/273,331

(22) Filed: Jul. 18, 2025

Related U.S. Application Data
(63) Continuation of application No. PCT/JP2024/000955, filed on Jan. 16, 2024.

(30) Foreign Application Priority Data
Jan. 30, 2023 (JP) 2023-011541

(51) Int. Cl. G05D 1/667; G05D 107/60

(52) U.S. Cl. CPC G05D 1/667; G05D 2107/63

(57) ABSTRACT

A data supply device includes: a data acquisition unit configured to acquire attribute data indicating at least one of content regarding a movable apparatus that moves autonomously in a space and content regarding a sensor used by the movable apparatus; a data selection unit configured to select, based on the attribute data, space data to be supplied to the movable apparatus from space data generated by measuring the space; a timing determination unit configured to determine, based on the attribute data, a timing at which the space data selected by the data selection unit is supplied to the movable apparatus; and a data supply unit configured to supply the space data selected by the data selection unit to the movable apparatus at the timing determined by the timing determination unit.

### CROSS-REFERENCE TO RELATED APPLICATIONS

This application is a Continuation of International Patent Application No. PCT/JP2024/000955, filed Jan. 16, 2024, which claims the benefit of Japanese Patent Application No. 2023-011541, filed Jan. 30, 2023, both of which are hereby incorporated by reference herein in their entirety.

### BACKGROUND

### Field of the Technology

The present disclosure relates to a data supply device, a storage medium, and a data supply method.

### Description of the Related Art

Currently, autonomous mobile robots capable of moving autonomously and performing tasks in various locations such as office buildings, residences, and logistics centers are being developed. Such mobile entities ascertain spaces as maps such as point group data or collections of feature points to move autonomously by causing a sensor to measure distances to objects located around the mobile entities. Examples of techniques that provide such maps to autonomously moving mobile entities include map information supply systems disclosed in Japanese Patent Application Laid-open No. 2021-77053.

Such a map information supply system includes a database, an image data generation unit, and a data transceiver unit. The database stores 3-dimensional point group data regarding an area where an autonomous mobile apparatus travels.

The image data generation unit cuts 2-dimensional point group data of a height designated by the autonomous mobile apparatus from the 3-dimensional point group data read from the database to generate 2-dimensional plane image data. The data transceiver unit can transmit 2-dimensional plane image data or point group data generated by the image data generation unit to the autonomous mobile apparatus.

However, some of the above-described map information supply systems may not supply such data to mobile entities at times at which 2-dimensional plane image data or point group data is actually used by the mobile entities. This is because timings at which such data is actually used differ depending on specifications of units of the mobile entities and performance or the like of units of the mobile entities.

### SUMMARY

According to an aspect of the present disclosure, a data supply device includes: a data acquisition unit configured to acquire attribute data indicating at least one of content regarding a movable apparatus that moves autonomously in a space and content regarding a sensor used by the movable apparatus; a data selection unit configured to select, based on the attribute data, space data to be supplied to the movable apparatus from space data generated by measuring the space; a timing determination unit configured to determine, based on the attribute data, a timing at which the space data selected by the data selection unit is supplied to the movable apparatus; and a data supply unit configured to supply the space data selected by the data selection unit to the movable apparatus at the timing determined by the timing determination unit.

Features of the present disclosure will become apparent from the following description of embodiments with reference to the attached drawings.

### BRIEF DESCRIPTION OF THE DRAWINGS

FIG. 1 is a diagram illustrating examples of a movable apparatus, a movable apparatus management apparatus and a user terminal according to an embodiment.

FIG. 2 is a diagram illustrating examples of a scenario in which the movable apparatus, the movable apparatus management apparatus, and the user terminal according to the embodiment are used.

FIG. 3 is a diagram illustrating an example of a hardware configuration of a data supply device according to the embodiment.

FIG. 4 is a diagram illustrating an example of a software configuration of the data supply device according to the embodiment.

FIG. 5 is a diagram illustrating an example of an evaluation value in a range of a distance that can be measured by a sensor according to the embodiment.

FIG. 6 is a diagram illustrating an example of an evaluation value in a range of an angle that can be measured by a sensor according to the embodiment.

FIG. 7 is a diagram illustrating an example of an evaluation value of a speed at which a movable apparatus moves according to the embodiment.

FIG. 8 is a diagram illustrating an example of an evaluation value of a scheme by which a movable apparatus moves according to the embodiment.

FIG. 9 is a flowchart illustrating an example of a process performed by the data supply device according to the embodiment.

FIG. 10 is a diagram illustrating examples of a movable apparatus, a movable apparatus management apparatus, a user terminal, and a monitoring camera according to the embodiment.

FIG. 11 is a diagram illustrating an evaluation value of a type of data transmitted to the movable apparatus management apparatus by the monitoring camera according to the embodiment.

### DESCRIPTION OF THE EMBODIMENTS

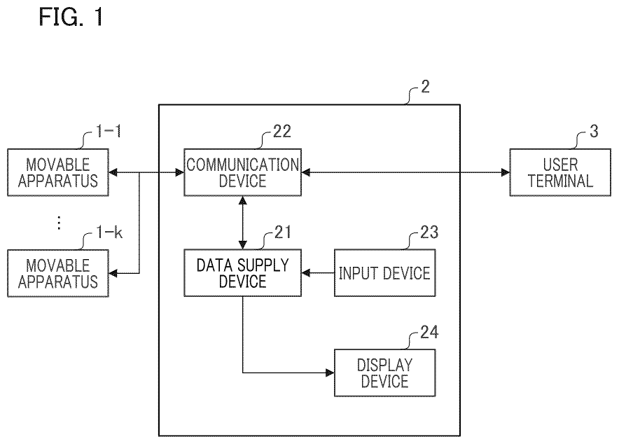

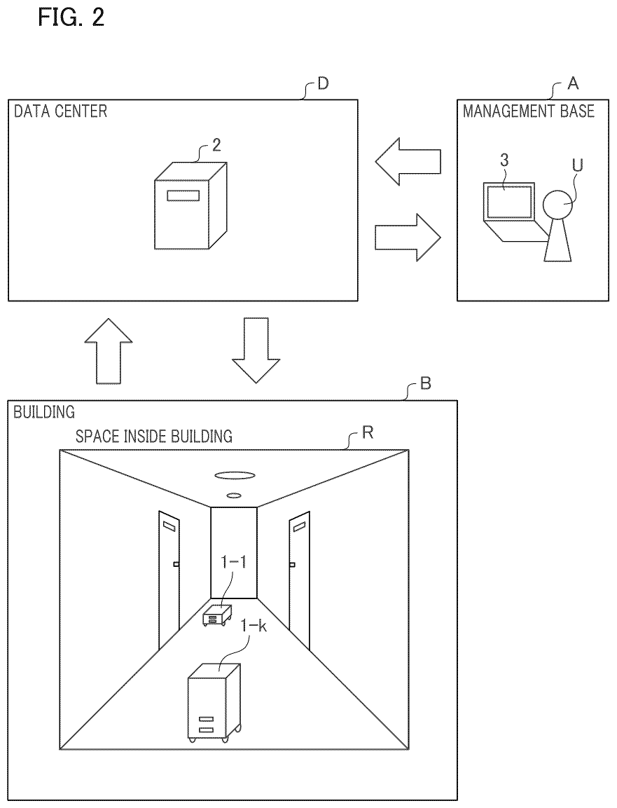

Hereinafter, an embodiment of the present disclosure will be described with reference to FIGS. 1 to 9. FIG. 1 is a diagram illustrating examples of a movable apparatus, the movable apparatus management apparatus and a user terminal according to an embodiment. FIG. 2 is a diagram illustrating examples of a scenario in which the movable apparatus, the movable apparatus management apparatus, and the user terminal according to the embodiment are used. FIGS. 1 and 2 illustrate a movable apparatus 1-1, . . . , and a movable apparatus 1-k (where k is an integer of 1 or more), a movable apparatus management apparatus 2, and a user terminal 3.

The movable apparatus 1-1, . . . , and the movable apparatus 1-k are autonomous mobile robots, unmanned automatic guided vehicles (AGVs), or the like that perform predetermined operations such as cleaning and load carrying in a space R in a building B such as an office building illustrated in FIG. 2.

Sensors are mounted on all the movable apparatus 1-1, . . . , and the movable apparatus 1-k. The sensor ascertains the space R around the own movable apparatus so that the movable apparatus moves autonomously in the space R. The sensor is, for example, a 2-dimensional or 3-dimensional light detection and ranging (LIDAR) or a stereo camera.

The movable apparatus 1-1, . . . , and the movable apparatus 1-k require a map of the space R when the mobile entities move autonomously inside the space R. This map is, for example, data in which the inside of the space R is expressed as point group data or a collection of feature points. In the following description, such data is referred to as space data.

The space data used as a map is generated by causing a sensor to measure the space R in advance. The sensor may be a sensor mounted on each of the movable apparatus 1-1, . . . , and the movable apparatus 1-k or another movable apparatus introduced in the space R or may be a sensor used by a worker measuring a distance to an object located in the space R. The space data may include data indicating content other than the point group data or the collection of feature points.

The movable apparatus management apparatus 2 is installed, for example, in a data center D illustrated in FIG. 2. The movable apparatus management apparatus 2 includes a data supply device 21, a communication device 22, an input device 23, and a display device 24, as illustrated in FIG. 1.

The data supply device 21 selects space data supplied to each of the movable apparatus 1-1, . . . , and the movable apparatus 1-k. Subsequently, the data supply device 21 determines each timing at which each piece of space data is supplied to each of the movable apparatus 1-1, . . . , and the movable apparatus 1-k. Then, the data supply device 21 supplies each piece of space data to each of the movable apparatus 1-1, . . . , and the movable apparatus 1-k at each of the determined timings. The details of the data supply device 21 will be described below.

The communication device 22 implements communication between the movable apparatus management apparatus 2 and the movable apparatus 1-1, . . . , and the movable apparatus 1-k or the user terminal 3. The input device 23 is, for example, a mouse or a keyboard and is used to input data, an instruction, and the like to the movable apparatus management apparatus 2. The display device 24 is, for example, a display and displays information directed towards a user U of the movable apparatus management apparatus 2.

The user terminal 3 is, for example, a computer installed in a management base A illustrated in FIG. 2. The user terminal 3 is used to manipulate the movable apparatus management apparatus 2 from the management base A that has a different location from the data center D.

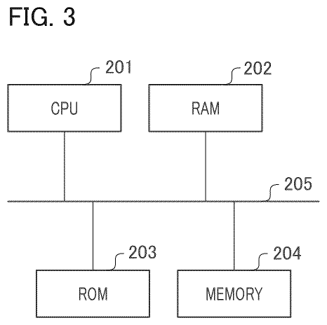

Next, a hardware configuration of the data supply device according to the embodiment will be described with reference to FIG. 3. FIG. 3 is a diagram illustrating an example of a hardware configuration of the data supply device according to the embodiment.

The data supply device 21 includes a central processing unit (CPU) 201, a random access memory (RAM) 202, a read only memory (ROM) 203, a memory 204, and a bus 205 illustrated in FIG. 3.

The CPU 201 implements each function of the data supply device 21 by reading and executing a program. The RAM 202 is a recording medium on which the program read and executed by the CPU 201 is temporarily loaded.

The ROM 203 is a recording medium in which the program read and executed by the CPU 201 is stored. The memory 204 is a recording medium in which distance data or the like to be described below is stored. The bus 205 connects the CPU 201, the RAM 202, the ROM 203, and the memory 204 to be able to communicate with each other.

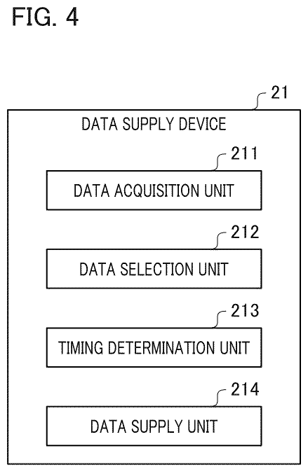

Next, a software configuration of the data supply device according to the embodiment will be described with reference to FIG. 4. FIG. 4 is a diagram illustrating an example of a software configuration of the data supply device according to the embodiment. The data supply device 21 includes a data acquisition unit 211, a data selection unit 212, a timing determination unit 213, and a data supply unit 214 illustrated in FIG. 4.

In the following description, the movable apparatus 1-1 will be described mainly, but the same applies to the mobile entities 1-2, . . . , and the movable apparatus 1-k. In the following description, when it is necessary to mention a plurality of mobile entities, the mobile entities 1-2, . . . , and the movable apparatus 1-k will be described as examples.

The data acquisition unit 211 acquires attribute data indicating at least one of content regarding the movable apparatus 1-1 that moves autonomously in the space R and content regarding a sensor used by the movable apparatus 1-1.

For example, the data acquisition unit 211 acquires the attribute data from the movable apparatus 1-1. Alternatively, the data acquisition unit 211 may acquire the attribute data from an apparatus that manages attribute data of the movable apparatus 1-1 or an apparatus that stores attribute data of the movable apparatus 1-1.

Alternatively, the data acquisition unit 211 may acquire attribute data input by a user who manages the movable apparatus 1-1. Alternatively, the data acquisition unit 211 may acquire attribute data by reading a code attached to the building B or the surface of the movable apparatus 1-1.

The content regarding the movable apparatus 1-1 is content regarding at least one of a model, a specification, a function, and performance of the movable apparatus 1-1. For example, the content regarding the movable apparatus 1-1 is content regarding at least one of a speed at which the movable apparatus 1-1 moves and a scheme by which the movable apparatus 1-1 moves.

The scheme by which the movable apparatus 1-1 moves is, for example, a roller type, a crawler type, a legged type, or a flying type. Alternatively, the content regarding the movable apparatus 1-1 is content regarding a function in which the movable apparatus 1-1 detects an object such as a person or an obstacle located in the space R. Additionally, the content regarding the movable apparatus 1-1 is content regarding an ability for the movable apparatus 1-1 to avoid an object.

The content regarding the sensor used by the movable apparatus 1-1 is content regarding at least one of a model, a specification, a function, and performance of the sensor. The sensor may be mounted on the movable apparatus 1-1 or may not be mounted on the movable apparatus 1-1.

For example, the content regarding the sensor used by the movable apparatus 1-1 is at least one of a range, accuracy, and a resolution of a distance that can be measured by the sensor. Alternatively, the content regarding the sensor used by the movable apparatus 1-1 is at least one of a range, accuracy, and a resolution of an angle that can be measured by the sensor. Alternatively, the content regarding the sensor used by the movable apparatus 1-1 is a position at which the sensor is mounted on the movable apparatus 1-1.

The attribute data may be at least one of a position and an orientation that the movable apparatus 1-1 takes in space R. Alternatively, the attribute data may indicate a route along which the movable apparatus 1-1 moves in the space R. Alternatively, the attribute data may indicate specific content of a predetermined operation that the movable apparatus 1-1 performs in the space R.

The data acquisition unit 211 may acquire object data indicating content regarding an object in the space R when the ability for the movable apparatus 1-1 to detect an object is equal to or less than a predetermined level. The object data indicates a position at which there is an object such as a person or an obstacle in the space R.

Alternatively, the object data indicates a place where objects such as people or obstacles easily gather in the space R. Alternatively, the object data indicates the degree of density indicating how densely objects such as people and obstacles are located in space R.

For example, the object data is preferably generated through a process of recognizing the positions, sizes, and shapes, and number of objects shown in an image captured by a camera and the degree of density indicating how densely the objects are located, and is updated when a given time has passed. The object data may be data independent from the space data or may be data included in the space data.

When there are a plurality of mobile entities and it is necessary to supply the space data for each movable apparatus, the data acquisition unit 211 performs a process of acquiring the above-described attribute data for each movable apparatus. Similarly, when there are a plurality of mobile entities and it is necessary to supply the space data for each movable apparatus, the data acquisition unit 211 may perform a process of acquiring the above-described object data for each movable apparatus.

Based on the attribute data, the data selection unit 212 selects space data to be supplied to the movable apparatus 1-1 from space data generated by measuring the space R. When there are a plurality of pieces of space data, the data selection unit 212 selects space data to be supplied to the movable apparatus 1-1 from the plurality of pieces of space data. When there is only one piece of space data and the space data is compatible with the attribute data, the data selection unit 212 may select the space data.

Specifically, the data selection unit 212 selects space data compatible to content indicated by the attribute data. For example, when the attribute data indicates that a sensor detecting an object such as a person is not mounted on the movable apparatus 1-1, a movable apparatus other than the movable apparatus 101, or an obstacle is not mounted on the movable apparatus 1-1, the data selection unit 212 select the following space data.

That is, in such as case, the data selection unit 212 selects space data including content indicating positions, sizes, and shapes of such objects and the degree of density indicating how densely the objects are located. In particular, the degree of density is easily increased at an entrance or the like of an office building. Further, since the degree of density is easily increased in a period of commuting time in the morning, a period of leaving time in the evening, or the like despite the entrance of the same office building, the degree of density may be calculated for each period of time.

Alternatively, when a 2-dimensional LIDAR is mounted on the movable apparatus 1-1, the data selection unit 212 selects space data including point group data generated by a 2-dimensional LIDAR capable of measuring the same height as the 2-dimensional LIDAR.

Alternatively, the data selection unit 212 selects space data including a broader range as a speed at which the movable apparatus 1-1 moves becomes faster. This is because the movable apparatus 1-1 moves in a broad range for a shorter time as the speed of the movement becomes faster.

Alternatively, the data selection unit 212 selects space data including a broader range as the extent that a scheme by which the movable apparatus 1-1 moves is compatible for movement of the space R is higher. This is because the movable apparatus 1-1 can move smoothly in the space R and move in a broader range for a shorter time as the extent that a scheme by which the movable apparatus 1-1 moves is compatible for movement of the space R is higher.

A data amount of the space data becomes larger as an included range becomes broader. Accordingly, the data supply device 21 is required to bring forward a timing at which the space data is supplied to the movable apparatus 1-1 as the data amount of the space data is larger.

The data supply device 21 can shorten a time sum necessary for a process of supplying space data to a plurality of mobile entities by advancing a timing at which the space data is supplied to the movable apparatus 1-1 as the data amount of the space data is larger.

When the ability for the movable apparatus 1-1 to detect an object is equal to or less than a predetermined level, the data selection unit 212 selects space data including object data indicating content regarding an object located in the space R.

The space data has a larger data amount by an amount of included object data. Conversely, when the ability for the movable apparatus 1-1 to detect an object exceeds the predetermined level, the data selection unit 212 selects space data not including object data indicating content regarding an object located in the space R. The space data has a smaller data amount by an amount of non-included object data.

When there are a plurality of mobile entities and the space data is supplied for each movable apparatus, the data selection unit 212 may evaluate content indicated by the attribute data by comparing the content indicated by the attribute data. The data selection unit 212 may select the space data to be supplied to each movable apparatus based on a result of the evaluation.

Based the attribute data, the timing determination unit 213 determines a timing at which the space data selected by the data selection unit 212 is supplied to the movable apparatus 1-1. The timing is a time at which the space data is supplied to the movable apparatus 1-1 or a priority of a process of supplying the space data to the movable apparatus 1-1.

When the space data is selected and supplied to each of the mobile entities of the movable apparatus 1-1, . . . , and the movable apparatus 1-k, the timing is a time at which each process of supplying the space data to the movable apparatus is executed or a priority of each process of supplying the space data to the movable apparatus.

The time at which the space data is supplied to the movable apparatus 1-1 is a period of time at which the space data is transmitted to the movable apparatus 1-1 or a time at which a process of transmitting the space data to the movable apparatus 1-1 starts.

For example, the timing determination unit 213 brings forward a timing at which the space data is supplied to the movable apparatus 1-1 as the ability for the movable apparatus 1-1 to detect an object is lower. This is because it is more difficult for the movable apparatus 1-1 to move smoothly while avoiding an object as the ability to detect an object is lower, and thus it is preferable to acquire the space data more quickly.

For example, the ability for the movable apparatus 1-1 to detect an object is a range of a distance that can be measured by a sensor. In this case, the timing determination unit 213 evaluates that the ability for the movable apparatus 1-1 to detect an object is low as the range is narrower.

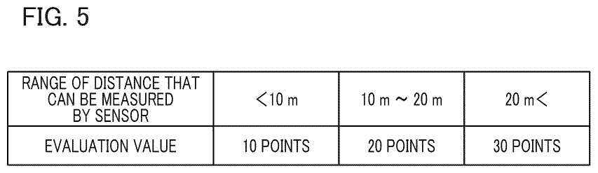

FIG. 5 is a diagram illustrating an example of an evaluation value in a range of a distance that can be measured by the sensor according to the embodiment. The first row of FIG. 5 indicates a range of a distance that can be measured by the sensor. The second row of FIG. 5 indicates an evaluation value for each range of the distance. The evaluation value means that the ability for the movable apparatus 1-1 to detect an object is lower as the value is smaller.

As illustrated in FIG. 5, the timing determination unit 213 sets the evaluation value to 10 points when the distance that can be measured by the sensor is less than 10 m. As illustrated in FIG. 5, the timing determination unit 213 sets the evaluation value to 20 points the distance that can be measured by the sensor is equal to or greater than 10 m and equal to or less than 20 m. As illustrated in FIG. 5, the timing determination unit 213 sets the evaluation value to 30 points when the distance that can be measured by the sensor is greater than 20 m.

The timing determination unit 213 may evaluate the ability for the movable apparatus 1-1 to detect an object depending on presence or absence of the ability for the movable apparatus 1-1 to detect an object. For example, when the sensor detecting an object is mounted on the movable apparatus 1-1, the timing determination unit 213 sets the evaluation value to 30 points.

Conversely, when the sensor detecting an object is not mounted on the movable apparatus 1-1, the timing determination unit 213 sets the evaluation value to 0. Examples of the sensor include a camera that has a function of recognizing an object shown in an image.

Alternatively, the ability for the movable apparatus 1-1 to detect an object is a range of an angle that can be measured by the sensor. In this case, the timing determination unit 213 evaluates that the ability for the movable apparatus 1-1 to detect an object is lower as the range is narrower.

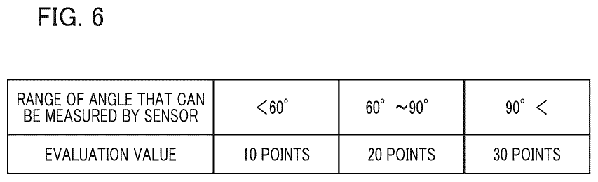

FIG. 6 is a diagram illustrating an example of an evaluation value in a range of an angle that can be measured by a sensor according to the embodiment. The first row of FIG. 6 indicates a range of an angle that can be measured by the sensor. The angle indicated in the first row of FIG. 6 is an angle on the left or right of the movable apparatus 1-1.

Accordingly, when the angle indicated in the first row of FIG. 6 is 60 degrees, the sensor of the movable apparatus 1-1 can measure a range of a sum of 120 degrees of 60 degrees on the left and 60 degrees on the right. The second row of FIG. 6 indicates an evaluation value for each range of the angle. The evaluation value means that the ability for the movable apparatus 1-1 to detect an object is lower as the value is smaller.

As illustrated in FIG. 6, when the angle that can be measured by the sensor is less than 60 degrees, the timing determination unit 213 sets the evaluation value to 10 points. As illustrated in FIG. 6, when the angle that can be measured by the sensor is equal to or greater than 60 degrees and equal to or less than 90 degrees, the timing determination unit 213 sets the evaluation value to 20 points. As illustrated in FIG. 6, when the angle that can be measured by the sensor is greater than 90 degrees, the timing determination unit 213 sets the evaluation value to 30 points.

When at least a part of the range of the angle that can be measured by each of a plurality of sensors does not overlap, the timing determination unit 213 may perform the above-described process in a range of an angle at which the ranges of the angles are added.

Alternatively, the timing determination unit 213 brings forward a timing at which the space data is supplied to the movable apparatus 1-1 as the speed at which the movable apparatus 1-1 moves becomes faster. This is because the movable apparatus 1-1 moves faster as the speed at which the movable apparatus 1-1 moves becomes faster, and thus the space data is preferably acquired faster.

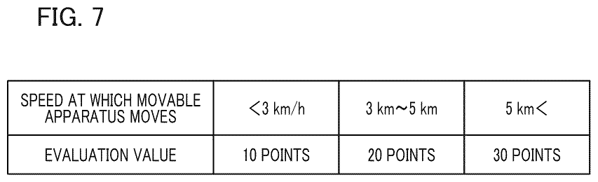

FIG. 7 is a diagram illustrating an example of an evaluation value of a speed at which a movable apparatus moves according to the embodiment. The first row of FIG. 7 indicates a speed at which the movable apparatus 1-1 moves. The second row of FIG. 7 indicates an evaluation value for each speed. The evaluation value means that the speed at which the movable apparatus 1-1 moves becomes faster when the value is larger.

For example, as illustrated in FIG. 7, when the speed at which the movable apparatus 1-1 moves is less than 3 km/h, the timing determination unit 213 sets the evaluation value to 10 points. As illustrated in FIG. 7, when the speed at which the movable apparatus 1-1 moves is equal to or greater than 3 km/h and equal to or less than 5 km/h, the timing determination unit 213 sets the evaluation value to 20 points. As illustrated in FIG. 7, when the speed at which the movable apparatus 1-1 moves is greater than 5 km/h, the timing determination unit 213 sets the evaluation value to 30 points.

Alternatively, the timing determination unit 213 brings forward a timing at which the space data is supplied to the movable apparatus 1-1 as the ability for the movable apparatus 1-1 to avoid an object is lower. This is because movement of the movable apparatus 1-1 can be obstructed more easily as an ability to avoid an object is lower, and the space data is preferably acquired faster.

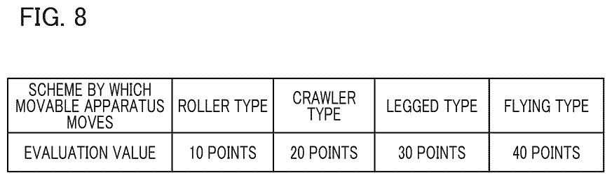

FIG. 8 is a diagram illustrating an example of an evaluation value of a scheme by which a movable apparatus moves according to the embodiment. The first row of FIG. 8 indicates a scheme by which the movable apparatus 1-1 moves. The second row of FIG. 8 indicates an evaluation value for each scheme. The evaluation values mean that the movable apparatus 1-1 can move smoothly in the space R as the value is larger.

For example, as illustrated in FIG. 8, when the scheme by which the movable apparatus 1-1 moves is a roller type, the timing determination unit 213 sets the evaluation value to 10 points. As illustrated in FIG. 8, when the scheme by which the movable apparatus 1-1 moves is a crawler type, the timing determination unit 213 sets the evaluation value to 20 points.

As illustrated in FIG. 8, when the scheme by which the movable apparatus 1-1 moves is a crawler type, the timing determination unit 213 sets the evaluation value to 30 points. As illustrated in FIG. 8, when the scheme by which the movable apparatus 1-1 moves is a flying type, the timing determination unit 213 sets the evaluation value to 40 points.

The timing determination unit 213 may perform the above-described process on at least two of the range of the distance that can be measured by the sensor, the range of the angle that can be measured by the sensor, the speed at which the movable apparatus 1-1 moves, and the scheme by which the movable apparatus 1-1 moves.

For example, when the distance that can be measured by the sensor is 15 m and the angle that can be measured by the sensor is 75 degrees, the timing determination unit 213 sets “20 points+20 points=40 points” with reference to FIGS. 5 and 6.

Alternatively, when the speed at which the movable apparatus 1-1 moves is 2 km/h and the scheme by which the movable apparatus 1-1 moves is a roller type, the timing determination unit 213 sets “10 points+10 points=20 points” with reference to FIGS. 7 and 8.

When the data acquisition unit 211 acquires object data, the timing determination unit 213 determines a timing at which the object data is supplied to the movable apparatus 1-1.

The timing determination unit 213 may determine a timing at which the space data selected by the data selection unit 212 is supplied to the movable apparatus 1-1 by determining a speed at which the space data is transmitted to the movable apparatus 1-1.

Alternatively, the timing determination unit 213 may determine a timing at which the object data selected by the data selection unit 212 is supplied to the movable apparatus 1-1 by determining a speed at which the space data is transmitted to the movable apparatus 1-1.

For example, the timing determination unit 213 determine a speed at which the space data is transmitted to the movable apparatus 1-1 through a process of selecting a frequency band or a channel in accordance with the degree of congestion of communication. Alternatively, the timing determination unit 213 determines a speed at which the space data is transmitted to the movable apparatus 1-1 through a process of increasing or decreasing the number of frequency bands or channels used for a process of transmitting at least one of the space data and the object data.

The timing determination unit 213 may use the following Formula (1) when a time at which the process of transmitting the space data to the movable apparatus 1-1 starts is determined as the above-described timing. Formula (1) includes time Tstart from a current time to a time at which the process of transmitting the space data to the movable apparatus 1-1, the above-described evaluation value Value, and coefficients α and β.

Tstart=Value×α+β Formula (1)

The timing determination unit 213 is required to supply the space data to each of the mobile entities 1-1, 1-2, and 1-3. When evaluation values of the three mobile entities are “20,” “40” and “60,” Formula (1) is used as follows.

In this case, the timing determination unit 213 sets α=5 and β=−40 for setting a time at which the process of transmitting the space data to the movable apparatus 1-1 with the lowest evaluation value starts to a time after 60 seconds from the current time. In this case, times at which the processes of transmitting the space data to the mobile entities 1-1, 1-2, and 1-3 start are times after 60 seconds, 160 seconds, and 260 seconds from the current time.

The timing determination unit 213 may determine a time at which the process of transmitting the space data to the movable apparatus 1-1 starts with reference to a table generated in advance.

The data supply unit 214 supplies the space data selected by the data selection unit 212 to the movable apparatus 1-1 at a timing determined by the timing determination unit 213. The movable apparatus 1-1 receives the space data from the data supply unit 214, then moves autonomously in the space R using the space data, and performs a predetermined operation as necessary.

When the data acquisition unit 211 acquires the object data, the data supply unit 214 supplies the object data to the movable apparatus 1-1 at the timing determined by the timing determination unit 213.

After the object data is received from the data supply unit 214, the movable apparatus 1-1 moves autonomously in the space R while avoiding an object located in the space R using the object data, and performs the predetermined operation as necessary.

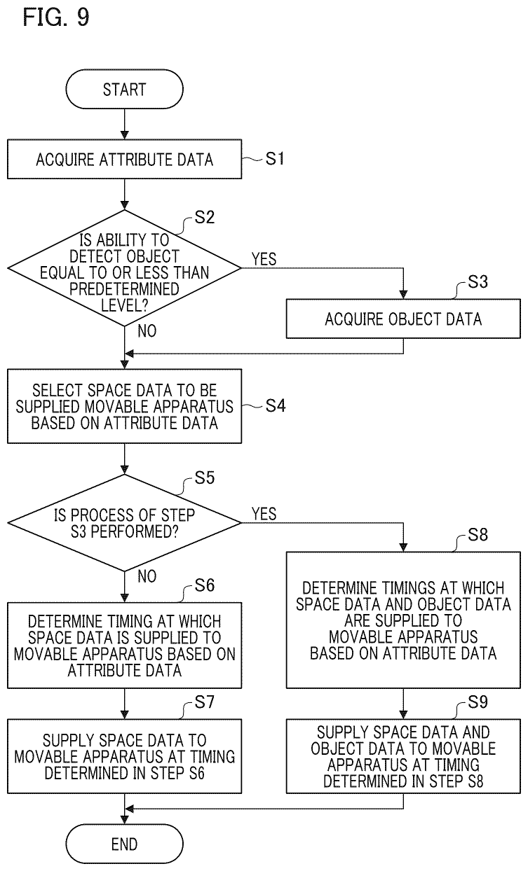

Next, an example of a process performed by the data supply device 21 will be described with reference to FIG. 9. FIG. 9 is a flowchart illustrating an example of a process performed by the data supply device according to the embodiment.

In step S1, the data acquisition unit 211 acquires the attribute data.

In step S2, the data acquisition unit 211 determines whether the ability for the movable apparatus 1-1 to detect an object is equal to or less than the predetermined level. When the data acquisition unit 211 determines that the ability for the movable apparatus 1-1 to detect an object is equal to or less than the predetermined level (YES in step S3), the process proceeds to step S3.

When the data acquisition unit 211 determines that the ability for the movable apparatus 1-1 to detect an object is greater than the predetermined level (NO in step S3), the process proceeds to step S4.

In step S3, the data acquisition unit 211 acquires the object data.

In step S4, the data selection unit 212 selects the space data to be supplied to the movable apparatus 1-1 based on the attribute data acquired in step S1.

In step S5, the timing determination unit 213 determines whether the process of step S3 is performed. When the timing determination unit 213 determines that the process of step S3 is performed (YES in step S5), the process proceeds to step S8.

Conversely, when the timing determination unit 213 determines that the process of step S3 is not performed (NO in step S5), the process proceeds to step S6.

In step S6, the timing determination unit 213 determines the timing at which the space data selected in step S4 is supplied to the movable apparatus 1-1 based on the attribute data.

In step S7, the data supply unit 214 supplies the space data to the movable apparatus 1-1 at the timing determined in step S6.

In step S8, the timing determination unit 213 determines the timing at which the space data selected in step S4 is supplied to the movable apparatus 1-1 and the timing at which the object data acquired in step S3 is supplied to the movable apparatus 1-1 based on the attribute data.

In step S9, the data supply unit 214 supplies the space data and the object data to the movable apparatus 1-1 at the timings determined in step S8.

The data supply device 21 may not perform steps S2, S3, S5, S8, and S9. In this case, the data supply device 21 performs step S4 after step S1 and performs step S6 after step S4.

The data supply device 21 according to the embodiment has been described above. The data supply device 21 determines the timing at which the space data is supplied to the movable apparatus 1-1 or the like based on the attribute data. Accordingly, the data supply device 21 can implement supplying the movable apparatus with data necessary for the movable apparatus 1-1 or the like to move autonomously in the space R at an appropriate timing and smooth moving of the movable apparatus.

The data supply device 21 can reduce a time necessary for a process of supplying the space data to supply the space data to the movable apparatus 1-1 or the like at an appropriate timing, and thus operate the system efficiently.

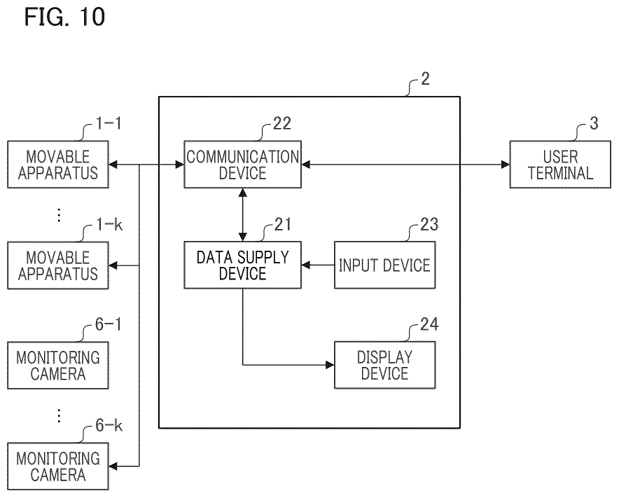

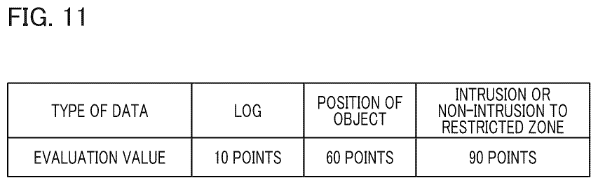

The data supply device 21 may perform processes to be described with reference to FIGS. 10 and 11 in a system that includes a monitoring camera. FIG. 10 is a diagram illustrating examples of a movable apparatus, a movable apparatus management apparatus, a user terminal, and a monitoring camera according to the embodiment.

FIG. 10 illustrates a monitoring camera 6-1, . . . , and a monitoring camera 6-m (where m is an integer of 1 or more and may be the same as k or may be different from k) in addition to the movable apparatus 1-1, . . . , and the movable apparatus 1-k, the movable apparatus management apparatus 2, and the user terminal 3. In the following description, the monitoring camera 6-1 will be described as an example, but the same applies to the monitoring camera 6-2, . . . , and the monitoring camera 6-k.

The monitoring camera 6-1 transmits data indicating a log, a position of an object, or intrusion or non-intrusion to a restricted zone to the movable apparatus management apparatus 2. The monitoring camera 6-1 transmits type data indicating a type of data to the movable apparatus management apparatus 2.

The type data is a type of attribute data and indicates, for example, data indicating a log, a position of an object, or intrusion or non-intrusion to a restricted zone. The type data indicates the degree of urgency when each piece of data is transmitted to the movable apparatus management apparatus 2.

The log indicates a record in which video data indicating a video temporarily stored in a recording medium mounted in the monitoring camera 6-1 is transmitted periodically to a recording medium mounted in the movable apparatus management apparatus 2.

The position of the object is a position of a person who is imaged by the monitoring camera 6-1 and a position of an object such as a movable apparatus. The intrusion or non-intrusion to a restricted zone means whether a person or an object such as a movable apparatus intrudes into a restricted zone imaged by the monitoring camera 1-1.

The timing determination unit 213 determines a timing at which data is received for the monitoring camera 6-1 based on the type data in addition to a timing at which the space data is supplied to each of the movable apparatus 1-1, . . . , and the movable apparatus 1-k.

That is, the timing determination unit 213 determines at least one of the timings based on an evaluation value regarding the movable apparatus 1-1 or the like and an evaluation value regarding the monitoring camera 6-1 or the like.

FIG. 11 is a diagram illustrating an evaluation value of a type of data transmitted to the movable apparatus management apparatus by the monitoring camera according to the embodiment. The first row of FIG. 11 indicates a type of data transmitted to the movable apparatus management apparatus 2 by the monitoring camera 6-1.

The second row of FIG. 11 indicates an evaluation value for each type of data. The evaluation values mean that the degree of urgency in the case of transmission to the movable apparatus management apparatus 2 is higher as the values are larger.

As illustrated in FIG. 11, in the case of data indicating the log, the evaluation value may be transmitted to the movable apparatus management apparatus 2 when a process of the data supply device 21 is not urgent. Therefore, the evaluation value is 10 points as a low score. As illustrated in FIG. 11, in the case of data indicating the position of the object, the evaluation value is useful for movement of the movable apparatus 1-1 or the like. Therefore, the evaluation value is 60 points as an intermediate score.

As illustrated in FIG. 11, in the case of data indicating the intrusion or non-intrusion to a restricted zone, it is preferable to check the movable apparatus 1-1 or the like as fast as possible. Therefore, the evaluation value is 90 points as a high score.

As described above, the timing determination unit 213 determines a timing at which data is received for the monitoring camera 6-1 based on the type data in addition to a timing at which the space data is supplied to each of the movable apparatus 1-1, . . . , and the movable apparatus 1-k. In this case, the timing at which the space data is supplied is brought forward as the evaluation value is lower. On the other hand, in this case, the timing at which the data is received is brought forward as the evaluation value is higher, in contrast to the timing at which the space data is supplied.

Accordingly, the timing determination unit 213 may set the evaluation value to a value obtained by subtracting each of the evaluation values illustrated in FIG. 11 from an evaluation value of 100 points to align with the timing at which the space data is supplied. In this case, the evaluation value regarding the log is 90 points.

In this case, the evaluation value regarding the position of the object is 40 points. In this case, the intrusion or non-intrusion to a restricted zone is 10 points. Accordingly, the timing determination unit 213 can generally determine a timing at which data is received from the monitoring camera 6-1.

In other words, accordingly, the timing determination unit 213 can bring forward a timing at which data is received from the monitoring camera 6-1 as the evaluation value is lower, similarly to the timing at which the space data is supplied to each of the movable apparatus 1-1, . . . , and the movable apparatus 1-k.

In the foregoing description, the monitoring camera 6-1, . . . , and the monitoring camera 6-m have been described as an example, but the present disclosure is not limited thereto. The data supply device 21 can also perform a similar process on a device other than the monitoring camera 6-1, . . . , and the monitoring camera 6-m.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the data supply device and so on through a network or various storage media. Then, a computer (or a CPU, an MPU, or the like) of the data supply device and so on may be configured to read and execute the program. In such a case, the program and the storage medium storing the program configure the present invention.

In addition, the present disclosure includes those realized using at least one processor or circuit configured to perform functions of the embodiments explained above. For example, a plurality of processors may be used for distribution processing to perform functions of the embodiments explained above.

What is claimed is:

1. A data supply device comprising:
at least one processor or circuit configured to function as:
a data acquisition unit configured to acquire attribute data indicating at least one of content regarding a movable apparatus that moves autonomously in a space and content regarding a sensor used by the movable apparatus;
a data selection unit configured to select, based on the attribute data, space data to be supplied to the movable apparatus from space data generated by measuring the space;
a timing determination unit configured to determine, based on the attribute data, a timing at which the space data selected by the data selection unit is supplied to the movable apparatus; and
a data supply unit configured to supply the space data selected by the data selection unit to the movable apparatus at the timing determined by the timing determination unit.

2. The data supply device according to claim 1,
wherein the data acquisition unit is configured to acquire the attribute data indicating content regarding a function of causing the movable apparatus to detect an object, and
wherein the timing determination unit is configured to cause the timing at which the space data is supplied to the movable apparatus to be brought forward as an ability for the movable apparatus to detect an object is lower.

3. The data supply device according to claim 1,
wherein the data acquisition unit is configured to acquire the attribute data indicating content regarding a function of causing the movable apparatus to detect an object and acquire object data indicating content regarding an object in the space when the ability for the movable apparatus to detect the object is equal to or less than a predetermined level,
wherein the timing determination unit is configured to determine a timing at which the object data acquired by the data acquisition unit is supplied to the movable apparatus, and
wherein the data supply unit is configured to supply the object data to the movable apparatus at the timing determined by the timing determination unit.

4. The data supply device according to claim 1,
wherein the data acquisition unit is configured to acquire the attribute data indicating content regarding a speed at which the movable apparatus moves, and
wherein the timing determination unit is configured to bring forward the timing at which the space data is supplied to the movable apparatus as the speed at which the movable apparatus moves becomes faster.

5. The data supply device according to claim 1,
wherein the data acquisition unit is configured to acquire the attribute data indicating content regarding an ability for the movable apparatus to avoid an object, and
wherein the timing determination unit is configured to bring forward the timing at which the space data is supplied to the movable apparatus as the ability for the movable apparatus to avoid the object is lower.

6. The data supply device according to claim 1,
wherein the data acquisition unit is configured to acquire the attribute data indicating content regarding a scheme by which the movable apparatus moves autonomously in a space, and
wherein the timing determination unit is configured to bring forward the timing at which the space data is supplied to the movable apparatus as a speed at which the movable apparatus moves in the space by the scheme becomes faster.

7. The data supply device according to claim 1, wherein the timing determination unit is configured to determine the timing at which the space data selected by the data selection unit is supplied to the movable apparatus by determining a speed at which the space data is transmitted to the movable apparatus.

8. The data supply device according to claim 3, wherein the timing determination unit is configured to determine the timing at which the object data selected by the data selection unit is supplied to the movable apparatus by determining a speed at which the object data is transmitted to the movable apparatus.

9. A non-transitory computer-readable storage medium storing a computer program including instructions for executing following processes:
acquiring attribute data indicating at least one of content regarding a movable apparatus that moves autonomously in a space and content regarding a sensor used by the movable apparatus;
selecting, based on the attribute data, space data to be supplied to the movable apparatus from space data generated by measuring the space;
determining, based on the attribute data, a timing at which the space data selected by the selecting is supplied to the movable apparatus; and
supplying the space data selected by the selecting to the movable apparatus at the timing determined by the determining.

10. A data supply method comprising:
acquiring attribute data indicating at least one of content regarding a movable apparatus that moves autonomously in a space and content regarding a sensor used by the movable apparatus;
selecting, based on the attribute data, space data to be supplied to the movable apparatus from space data generated by measuring the space;
determining, based on the attribute data, a timing at which the space data selected by the selecting is supplied to the movable apparatus; and
supplying the space data selected by the selecting to the movable apparatus at the timing determined by the determining.
